(19) United States
(12) Patent Application Publication
(10) Pub. No.: US 2026/0322805 A1
(43) Pub. Date: Oct. 15, 2026

(54) AUTHENTICATION METHOD FOR INFORMATION ACCESS, AUTHENTICATION DEVICE FOR INFORMATION ACCESS, AND AUTHENTICATION PROGRAM FOR INFORMATION ACCESS

(71) Applicant: FUJIFILM Corporation, Tokyo (JP)

(72) Inventors: Atsushi ITO, Kanagawa (JP); Yutaka OISHI, Kanagawa (JP); Yuko MASUDA, Kanagawa (JP); Shinnosuke SONODA, Kanagawa (JP); Shohei YANO, Kanagawa (JP); Yuji AKADA, Kanagawa (JP); Sae NESHIBA, Kanagawa (JP)

(73) Assignee: FUJIFILM Corporation, Tokyo (JP)

(21) Appl. No.: 19/699,027

(22) Filed: Jun. 5, 2026

Related U.S. Application Data
(63) Continuation of application No. PCT/JP2024/042216, filed on Nov. 28, 2024.

(30) Foreign Application Priority Data
Dec. 8, 2023 (JP) 2023-208029

(51) Int. Cl. H04L 9/40

(52) U.S. Cl. CPC H04L 63/083

(57) ABSTRACT

Provided is an authentication method for information access, the authentication method executing processing of comparing first authentication information with registered first authentication information, receiving, in a case where the comparison is confirmed, contact information for contacting a user as second authentication information; calculating a hash value of the received second authentication information, comparing the calculated hash value with a registered hash value, transmitting, in a case where the comparison of the hash value is confirmed, an arbitrary code to a contact information destination, receiving the transmitted code, and comparing the received code with the code transmitted to the contact information destination.

### CROSS-REFERENCE TO RELATED APPLICATIONS

This application is a continuation application of International Application No. PCT/JP2024/042216, filed Nov. 28, 2024, the disclosure of which is incorporated herein by reference in its entirety. Further, this application claims priority from Japanese Patent Application No. 2023-208029, filed Dec. 8, 2023, the disclosure of which is incorporated herein by reference in its entirety.

### BACKGROUND

### 1. Technical Field

The present disclosure relates to an authentication method for information access, an authentication device for information access, and an authentication program for information access.

### 2. Related Art

JP2010-79795A discloses a technique related to an authentication method in a case of two-factor authentication.

### SUMMARY

In a case of user authentication, contact information for contacting a user, such as an e-mail address or a telephone number, is widely used. For example, there is an example in which an e-mail address is used for a user account, and there is an example in which contact information is used as a possession element in addition to two-factor authentication or a knowledge element such as a password. However, in some countries, contact information is considered important personal information, and transfer abroad is strictly restricted. Therefore, in a system that provides a service from abroad, contact information for contacting a user, such as an e-mail address or a telephone number, cannot be stored in a persistent storage and used.

The present disclosure has been made in view of the above points, and an object of the present disclosure is to provide an authentication method for information access, an authentication device for information access, and an authentication program for information access that perform user authentication without storing contact information for contacting a user.

In order to achieve the above object, according to the present disclosed technology, there is provided an authentication method for information access, the authentication method comprising causing a processor to execute processing of receiving first authentication information from a device, comparing the received first authentication information with registered first authentication information, receiving, in a case where the comparison is confirmed, contact information for contacting a user as second authentication information, calculating a hash value of the received second authentication information, comparing the calculated hash value with a registered hash value, transmitting, in a case where the comparison of the hash value is confirmed, an arbitrary code to a contact information destination, receiving the transmitted code, and comparing the received code with the code transmitted to the contact information destination.

In a case where the comparison of the hash value is confirmed, the processor may execute processing of generating the code, and transmitting the generated code to the contact information destination.

The contact information may be an e-mail address and/or a telephone number of the user.

The first authentication information may be a user ID or a user ID and a password.

The first authentication information is a digital signature generated by using a private key recorded in the device, and the processor may verify the received digital signature by using a registered public key.

In order to achieve the above object, according to the present disclosed technology, there is provided an authentication device for information access, comprising a processor, in which the processor executes processing of receiving first authentication information from a device, comparing the received first authentication information with registered first authentication information, receiving, in a case where the comparison is confirmed, contact information for contacting a user as second authentication information, calculating a hash value of the received second authentication information, comparing the calculated hash value with a registered hash value, transmitting, in a case where the comparison of the hash value is confirmed, an arbitrary code to a contact information destination, receiving the transmitted code, and comparing the received code with the code transmitted to the contact information destination.

In order to achieve the above object, according to the present disclosed technology, there is provided an authentication program for information access causing a computer to execute a process, the process comprising receiving first authentication information from a device, comparing the received first authentication information with registered first authentication information, receiving, in a case where the comparison is confirmed, contact information for contacting a user as second authentication information, calculating a hash value of the received second authentication information, comparing the calculated hash value with a registered hash value, transmitting, in a case where the comparison of the hash value is confirmed, an arbitrary code to a contact information destination, receiving the transmitted code, and comparing the received code with the code transmitted to the contact information destination.

According to the present disclosure, it is possible to provide an authentication method for information access, an authentication device for information access, and an authentication program for information access that perform user authentication without storing contact information for contacting a user.

### BRIEF DESCRIPTION OF THE DRAWINGS

Exemplary embodiments according to the technique of the present disclosure will be described in detail based on the following figures, wherein:

FIG. 1 is a diagram showing a schematic configuration of an authentication system according to an embodiment of the disclosed technology.

FIG. 2 is a block diagram showing a hardware configuration of an authentication server.

FIG. 3 is a block diagram showing an example of a functional configuration of the authentication server.

FIG. 4 is a flowchart showing a flow of an authentication process for information access by the authentication server.

### DETAILED DESCRIPTION

Hereinafter, examples of embodiments of the present disclosure will be described with reference to the drawings. The same or equivalent constituents and parts in each drawing will be designated by the same reference signs. In addition, dimensional ratios in the drawings are exaggerated for convenience of description and may be different from the actual ratios.

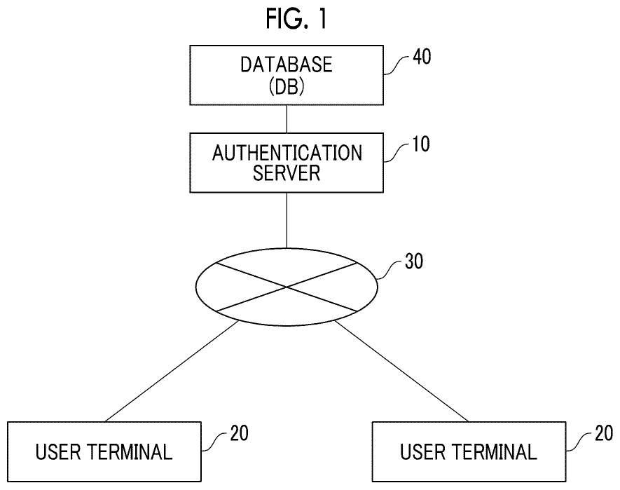

FIG. 1 is a diagram showing a schematic configuration of an authentication system according to the present embodiment. The authentication system shown in FIG. 1 includes an authentication server 10 and a user terminal 20. The authentication server 10 and the user terminal 20 are connected to each other to be communicable with each other through a network 30 such as the Internet. Although two user terminals 20 are shown in FIG. 1, the number of user terminals 20 is not limited to this example.

The authentication server 10 executes processing of confirming whether or not there is a use right for a predetermined service by two-factor authentication. The authentication server 10 is an example of an “authentication device for information access” of the present disclosure. The user terminal 20 is a terminal that uses the service and is an information processing apparatus such as a personal computer, a smartphone, or a tablet terminal. The user terminal 20 is an example of a device of the present disclosure. The user terminal 20 executes client software. The client software is software used by a user who operates the user terminal 20, and may be both service-specific software and general-purpose software. For example, in a case where a predetermined service uses a Web application, the client software is a general-purpose Web browser.

The authentication server 10 is connected to a database (DB) 40. The database 40 stores information for authenticating the user. In the present embodiment, the database 40 stores, as the information for authenticating the user, a hash value of contact information of the user, for example, an e-mail address and/or a telephone number of the user.

In the present embodiment, the authentication server 10 compares first authentication information transmitted from the user terminal 20 with registered first authentication information. The first authentication information is, for example, a user ID and a password. In a case where the authentication using the first authentication information is confirmed, the authentication server 10 receives second authentication information different from the first authentication information from the user terminal 20, calculates a hash value of the received second authentication information, and compares the calculated hash value with the hash value registered in the database 40. In a case where the comparison of the hash value is confirmed, the authentication server 10 transmits an arbitrary code to the user terminal 20.

In the present embodiment, the authentication server 10 acquires the e-mail address and/or the telephone number as the second authentication information from the user terminal 20. The authentication server 10 uses the e-mail address and/or the telephone number acquired from the user terminal 20 only for authentication and does not permanently store the e-mail address and/or the telephone number. Accordingly, for example, even in a case where the authentication server 10 is present in a country different from a country in which the user terminal 20 is present and the e-mail address or the telephone number is not desired to be stored or cannot be stored in the authentication server 10, the authentication system according to the present embodiment can realize two-factor authentication.

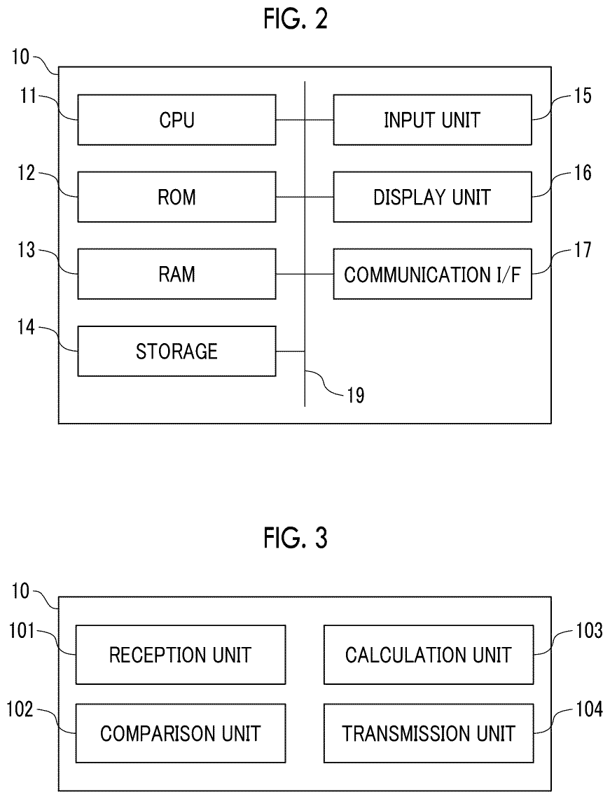

FIG. 2 is a block diagram showing a hardware configuration of the authentication server 10.

As shown in FIG. 2, the authentication server 10 includes a central processing unit (CPU) 11, a read only memory (ROM) 12, a random access memory (RAM) 13, a storage 14, an input unit 15, a display unit 16, and a communication interface (I/F) 17. Each configuration is mutually communicably connected through a bus 19.

The CPU 11 is a central processing unit, and executes various programs and controls each unit. That is, the CPU 11 reads out a program from the ROM 12 or the storage 14 and executes the program using the RAM 13 as a work area. The CPU 11 controls each configuration and performs various types of arithmetic processing according to the program registered in the ROM 12 or the storage 14. In the present embodiment, the ROM 12 or the storage 14 stores an authentication program for information access for authenticating the user.

The ROM 12 stores various programs and various data. The RAM 13 as a work area temporarily stores the program or the data. The storage 14 is configured by a storage device such as a hard disk drive (HDD), a solid-state drive (SSD), or a flash memory and stores various programs including an operating system and various data.

The input unit 15 includes a pointing device such as a mouse, and a keyboard, and is used to perform various inputs.

The display unit 16 is, for example, a liquid crystal display, and displays various types of information. The display unit 16 may adopt a touch panel type to function as the input unit 15.

The communication interface 17 is an interface for communicating with other devices such as the user terminal 20, and uses standards such as Ethernet (registered trademark), FDDI, and Wi-Fi (registered trademark).

In a case where the authentication program for information access is executed, the authentication server 10 implements various functions by using the above-described hardware resources. A functional configuration implemented by the authentication server 10 will be described.

FIG. 3 is a block diagram showing an example of a functional configuration of the authentication server 10.

As shown in FIG. 3, the authentication server 10 includes a reception unit 101, a comparison unit 102, a calculation unit 103, and a transmission unit 104 as a functional configuration. Each functional configuration is implemented by the CPU 11 reading out and executing the authentication program for information access stored in the ROM 12 or the storage 14.

The reception unit 101 receives various types of information related to the use of the service from the user terminal 20 through the network 30.

In a case where the user is authenticated, the reception unit 101 first receives a user ID and a password for using the service from the user terminal 20 through the network 30. In a case where the received user ID and password match the registered user ID and password, the reception unit 101 subsequently receives contact information of the user, for example, an e-mail address and/or a telephone number from the user terminal 20 through the network 30. In a case where a hash value of the e-mail address and/or the telephone number matches a registered hash value, the reception unit 101 receives an authentication code for authentication from the user terminal 20 through the network 30.

The comparison unit 102 executes a comparison process using the information received by the reception unit 101. The comparison unit 102 first compares the user ID and password received by the reception unit 101 with the user ID and password registered in advance. The user ID and password are stored in, for example, the storage 14.

In a case where the user ID and password received by the reception unit 101 match the user ID and password registered in advance, the comparison unit 102 subsequently compares a hash value calculated by the calculation unit 103 for the e-mail address and/or the telephone number received by the reception unit 101 with a hash value registered in the database 40. In a case where the hash value calculated by the calculation unit 103 matches the hash value registered in the database 40, the comparison unit 102 subsequently compares the authentication code received by the reception unit 101 with an authentication code transmitted by the transmission unit 104. Finally, in a case where the authentication code received by the reception unit 101 matches an authentication code transmitted by the transmission unit 104, the authentication of the user terminal 20 is completed, and the user terminal 20 is permitted to use the service.

The reception unit 101 may receive a digital signature generated using a private key recorded in the user terminal 20 instead of the user ID and password. In a case where the digital signature generated by the user terminal 20 is received, the comparison unit 102 authenticates the received digital signature using the public key registered in the authentication server 10. As a result, the authentication server 10 can verify whether or not the correspondence between the user and the public key is appropriate. In this case, the digital signature received by the reception unit 101 is an example of the first authentication information of the present disclosure.

The calculation unit 103 executes a calculation process of the hash value. Specifically, the calculation unit 103 calculates the hash value of the contact information of the user, for example, the e-mail address and/or the telephone number. The hash value calculated by the calculation unit 103 is used for the comparison process in the comparison unit 102.

The transmission unit 104 transmits various types of information to the user terminal 20 through the network 30. Specifically, the transmission unit 104 transmits information related to the comparison process in the comparison unit 102 to the user terminal 20. As the information related to the comparison process in the comparison unit 102, information on the result of each comparison and authentication information for authenticating the use of the system in a case where the hash values match are transmitted. The authentication information for authenticating the use of the system is, for example, a personal identification number (PIN) code, a one-time password, or the like.

In a case where the result of the comparison of the user ID and the password, the result of the comparison of the hash value, and the result of the comparison of the authentication code all match, the transmission unit 104 transmits a message indicating that the authentication is successful to the user terminal 20. On the other hand, in a case where any of the result of the comparison of the user ID and the password, the result of the comparison of the hash value, and the result of the comparison of the authentication code does not match, the transmission unit 104 transmits a message indicating that the authentication has failed to the user terminal 20. In a case where the authentication is successful, the user terminal 20 displays a message indicating that the authentication is successful, and the system can be used. In a case where the authentication has failed, the user terminal 20 displays a message indicating that the authentication has failed, and the system cannot be used.

The authentication server 10 can perform the user authentication without storing the contact information itself for contacting the user by having such a configuration. For example, even in a case where a country in which the authentication server 10 is installed strictly restricts the transfer of the contact information to a foreign country because the contact information is considered to be important personal information and the contact information cannot be stored in a persistent storage and used, the user authentication using the hash value of the contact information can be performed instead of using the contact information itself for contacting the user.

Next, an operation of the authentication server 10 will be described.

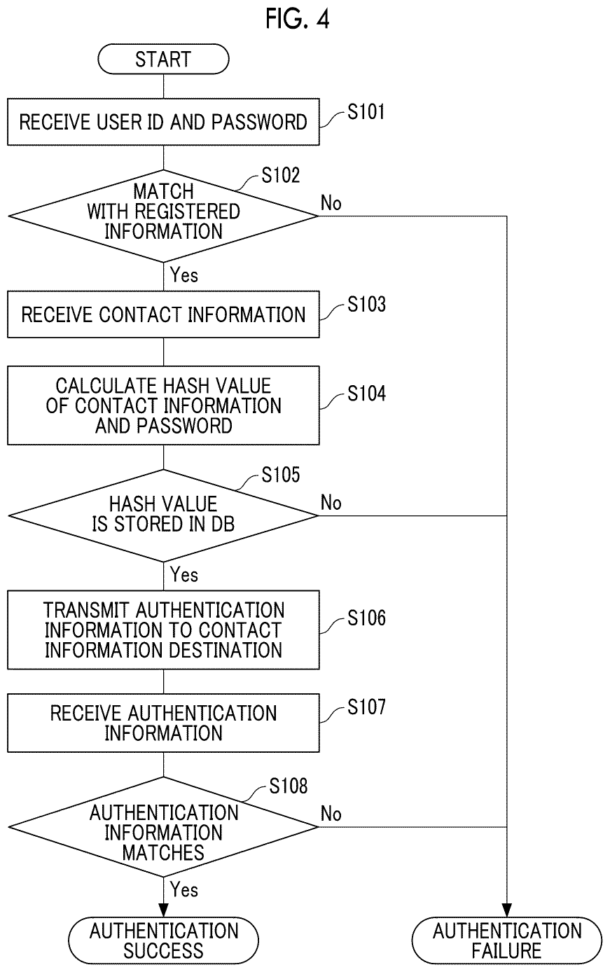

FIG. 4 is a flowchart showing a flow of an authentication process for information access by the authentication server 10. The CPU 11 reads out the authentication program for information access from the ROM 12 or the storage 14, loads the authentication program for information access into the RAM 13, and executes the authentication program for information access, so that the authentication process for information access is executed.

In step S101, the CPU 11 receives the user ID and the password of the system from the user terminal 20 that attempts to use the system.

Subsequently to step S101, in step S102, the CPU 11 determines whether or not the user ID and the password received from the user terminal 20 match the user ID and the password registered in advance.

In step S102, in a case where the user ID and the password received from the user terminal 20 do not match the user ID and the password registered in advance (step S102; No), the CPU 11 ends the authentication process as an authentication failure. In step S102, in a case where the user ID and the password received from the user terminal 20 match the user ID and the password registered in advance (step S102; Yes), in step S103, the CPU 11 receives the contact information of the user who attempts to use the system, for example, the e-mail address and/or the telephone number of the user, from the user terminal 20 for authentication of the use of the system.

Subsequently to step S103, in step S104, the CPU 11 calculates the hash value of the contact information received from the user terminal 20. Here, the CPU 11 may calculate not only the hash value of the contact information received from the user terminal 20 but also the hash value of the password received in step S101.

Subsequently to step S104, in step S105, the CPU 11 determines whether or not the calculated hash value matches the hash value registered in advance in the database 40.

In step S105, in a case where the calculated hash value does not match the hash value registered in advance in the database 40 (step S105; No), the CPU 11 ends the authentication process as an authentication failure. In step S105, in a case where the calculated hash value matches the hash value registered in advance in the database 40 (step S105; Yes), in step S106, the CPU 11 transmits the authentication information for authentication of the use of the system to the contact information received in step S103. The authentication information for authentication of the use of the system is, for example, a PIN code, a one-time password, or the like.

Subsequently to step S106, in step S107, the CPU 11 receives the authentication information for authentication of the use of the system from the user terminal 20.

Subsequently to step S107, in step S108, the CPU 11 determines whether or not the received authentication information matches the authentication information transmitted in step S106.

In step S108, in a case where the received authentication information does not match the authentication information transmitted in step S106 (step S108; No), the CPU 11 ends the authentication process as an authentication failure. In step S108, in a case where the received authentication information matches the authentication information transmitted in step S106 (step S108; Yes), the CPU 11 ends the authentication process as an authentication success.

The authentication server 10 can perform the user authentication without storing the contact information itself for contacting the user by executing such a process. For example, even in a case where a country in which the authentication server 10 is installed strictly restricts the transfer of the contact information to a foreign country because the contact information is considered to be important personal information and the contact information cannot be stored in a persistent storage and used, the user authentication using the hash value of the contact information can be performed instead of using the contact information itself for contacting the user.

The embodiments of the present disclosure have been described in detail with reference to the accompanying drawings, but the technical scope of the present disclosure is not limited to such examples. It is apparent that those having ordinary knowledge in the technical field of the present disclosure can conceive various change examples or modification examples within the technical idea described in the claims, and it is also understood that these change examples or modification examples belong to the technical scope of the present disclosure.

In addition, the effects described in the above-described embodiment are merely explanatory or exemplary examples, and the present disclosure is not limited to the effects described in the above-described embodiment. That is, the technique according to the present disclosure can exhibit other effects that are obvious to a person having ordinary knowledge in the technical field of the present disclosure from the description in the embodiment described above, in addition to the effects described in the embodiment described above or instead of the effects described in the embodiment described above.

In the present specification, “A and/or B” is synonymous with “at least one of A or B”. That is, “A and/or B” means that it may be only A, only B, or a combination of A and B. In addition, in the present specification, in a case where three or more matters are expressed by being connected by “and/or”, the same concept as “A and/or B” is applied.

Note that various processors other than the CPU may execute the authentication process for information access executed by the CPU reading the software (program) in each embodiment described above. Examples of the processors in this case include a programmable logic device (PLD) of which a circuit configuration can be changed after manufacture, such as a field-programmable gate array (FPGA), and a dedicated electric circuit that is a processor having a circuit configuration dedicatedly designed to execute specific processing, such as an application specific integrated circuit (ASIC). In addition, the authentication process for information access may be executed by one of these various processors, or may be executed by a combination of two or more processors of the same type or different types (for example, a plurality of FPGAs, a combination of a CPU and an FPGA, or the like). Furthermore, the hardware structures of the various processors are more specifically electrical circuitry where circuit elements, such as semiconductor elements, are combined.

In addition, in each of the above-described embodiments, an aspect in which the authentication program for information access is stored (installed) in advance in the ROM or the storage has been described, but the present disclosure is not limited thereto. The program may be provided by being recorded in a non-transitory recording medium such as a compact disk read only memory (CD-ROM), a digital versatile disk read only memory (DVD-ROM), and a Universal Serial Bus (USB) memory. Alternatively, a form in which the program is downloaded from an external apparatus through a network may be available.

The supplementary notes of the present disclosure will be described below.

### Supplementary Note 1

An authentication method for information access, the authentication method comprising:
causing a processor to execute processing of:
receiving first authentication information from a device;
comparing the received first authentication information with registered first authentication information;
receiving, in a case where the comparison is confirmed, contact information for contacting a user as second authentication information;
calculating a hash value of the received second authentication information;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.

### Supplementary Note 2

The authentication method for information access according to claim 1,
in which, in a case where the comparison of the hash value is confirmed, the processor executes processing of:
generating the code; and
transmitting the generated code to the contact information destination.

### Supplementary Note 3

The authentication method for information access according to Supplementary Note 1 or 2,
in which the contact information is an email address and/or a telephone number of the user.

### Supplementary Note 4

The authentication method for information access according to any one of Supplementary Notes 1 to 3,
in which the first authentication information is a user ID or a user ID and a password.

### Supplementary Note 5

The authentication method for information access according to any one of Supplementary Notes 1 to 3,
in which the first authentication information is a digital signature generated by using a private key recorded in the device, and
the processor verifies the received digital signature by using a registered public key.

### Supplementary Note 6

An authentication device for information access, comprising:
a processor,
in which the processor executes processing of:
receiving first authentication information from a device;
comparing the received first authentication information with registered first authentication information;
receiving, in a case where the comparison is confirmed, contact information for contacting a user as second authentication information;
calculating a hash value of the received second authentication information;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.

### Supplementary Note 7

An authentication program for information access causing a computer to execute a process, the process comprising:
receiving first authentication information from a device;
comparing the received first authentication information with registered first authentication information;
receiving, in a case where the comparison is confirmed, contact information for contacting a user as second authentication information;
calculating a hash value of the received second authentication information;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.

The disclosure of JP 2023-208029 filed on Dec. 8, 2023 is incorporated in the present specification by reference in its entirety.

All documents, patent applications, and technical standards described in the present specification are incorporated herein by reference to the same extent as in a case of being specifically and individually noted that individual documents, patent applications, and technical standards are incorporated herein by reference.

What is claimed is:

1. An authentication method for information access, the authentication method comprising:
causing a processor to execute processing of:
receiving first authentication information from a device;
comparing the received first authentication information with registered first authentication information;
receiving, in a case where the comparison is confirmed, contact information for contacting a user as second authentication information;
calculating a hash value of the received second authentication information and a password;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.

2. The authentication method for information access according to claim 1,
wherein, in a case where the comparison of the hash value is confirmed, the processor executes processing of:
generating the code; and
transmitting the generated code to the contact information destination.

3. The authentication method for information access according to claim 1,
wherein the contact information is an email address and/or a telephone number of the user.

4. The authentication method for information access according to claim 1,
wherein the first authentication information is a user ID or a user ID and a password.

5. The authentication method for information access according to claim 1,
wherein the first authentication information is a digital signature generated by using a private key recorded in the device, and
the processor verifies the received digital signature by using a registered public key.

6. An authentication device for information access, comprising:
a processor,
wherein the processor executes processing of:
receiving first authentication information from a device;
comparing the received first authentication information with registered first authentication information;
receiving, in a case where the comparison is confirmed, contact information for contacting a user as second authentication information;
calculating a hash value of the received second authentication information and a password;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.

7. An authentication program for information access causing a computer to execute a process, the process comprising:
receiving first authentication information from a device;
comparing the received first authentication information with registered first authentication information;
receiving, in a case where the comparison is confirmed, contact information for contacting a user as second authentication information;
calculating a hash value of the received second authentication information and a password;
comparing the calculated hash value with a registered hash value;
transmitting, in a case where the comparison of the hash value is confirmed, an arbitrary code to a contact information destination;
receiving the transmitted code; and
comparing the received code with the code transmitted to the contact information destination.
